(19) United States
(12) Patent Application Publication
(10) Pub. No.: US 2010/0060701 A1
(43) Pub. Date: Mar. 11, 2010

(54) LIQUID CONTAINER

(75) Inventors: Hitoshi Takada, Yokohama-shi (JP); Nobuyuki Hatasa, Kawasaki-shi (JP); Hideki Ogura, Yokohama-shi (JP); Hironori Murakami, Yokohama-shi (JP); Masaya Uetsuki, Yokohama-shi (JP); Hideo Fukazawa, Chigasaki-shi (JP); Eiichi Adachi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/556,502

(22) Filed: Sep. 9, 2009

(30) Foreign Application Priority Data
Sep. 10, 2008 (JP) 2008-232319

(51) Int. Cl. B41J 2/175

(52) U.S. Cl. 347/86

(57) ABSTRACT

An inner-pressure-changing connecting portion that changes the inner pressure of an ink cartridge and a fitted portion to be fitted on a positioning mechanism provided on an ink-jet printer are disposed coaxially. In a configuration for supplying ink by applying pressure to a pressure chamber, high-accuracy positioning of the ink cartridge and the ink-jet printer can be achieved.

### BACKGROUND OF THE INVENTION

1. Field of the Invention

The present invention relates to a liquid container for containing liquid, such as ink.

2. Description of the Related Art

An ink-jet printer (hereinafter referred to as a liquid ejecting apparatus) constructs an ink-jet print system (hereinafter also referred to as a liquid ejection system) when ink cartridges (hereinafter also referred to as liquid containers) that contain liquid, such as ink, are mounted. The ink-jet printer has a liquid supply system for supplying ink from the ink cartridges to an ink-jet print head (hereinafter also referred to as a liquid ejection head). An example of the liquid supply system is a system in which ink cartridges are fixed in an ink-jet printer and ink is supplied from the ink cartridges to the ink-jet print head through ink channels formed of flexible tubes.

Large-scale ink-jet printers capable of printing on large-sized paper have recently been used. Such large-scale ink-jet printers adopt a liquid supply system further having subtanks in the middle of ink supply channels that connect the ink-jet print heads and the ink cartridge. This supply system has independent ink supply channels from the ink cartridges to the subtanks and from the subtanks to the liquid ejection head. A known example of the configuration for supplying ink from the ink cartridges to the subtanks is disclosed in US 2007/0040874.

The ink cartridges disclosed in US 2007/0040874 each have an ink bag that contains ink and a pressure chamber in its tank case. The pressure chamber is connected to a pressure-fluid inlet of the apparatus main body. When pressure is applied to the pressure chamber, the ink bag is compressed to push out the ink toward the subtank. The ink cartridges disclosed in US 2007/0040874 each further include many fitting portions for fitting with the recoding-apparatus main body, such as positioning fitting portions at two locations, a pressure-fluid inlet, a liquid outlet, a data recording unit, and an improper-insertion preventing mechanism. Since this invention employs a configuration to supply ink by pressure, the pressure chamber must have a sealed structure, and therefore, it is particularly important to locate the positioning fitting portions and the pressure-fluid inlet with high accuracy. In contrast, the liquid inlet, the data recording unit, the improper-insertion preventing mechanism, etc. do not require such high-accuracy positioning. US 2007/0040874 solves the problem of high-accuracy positioning by using the two positioning fitting portions.

Meanwhile, ink-jet printers generate ink that is not used in printing (hereinafter also referred to as waste ink or waste liquid) due to the preejecting operation of the ink-jet print head or an ink recovery operation, such as an ink sucking operation. An example of a configuration for recovering the generated waste ink is disclosed in Japanese Patent Laid-Open No. 7-81089. Japanese Patent Laid-Open No. 7-81089 adopts a configuration in which a negative-pressure suction pump is joined to a waste-ink tank provided in the ink-jet printer, and the pressure in the waste-ink tank itself is reduced so that the waste ink is recovered into a waste-ink absorber.

An example of a configuration in which a waste-ink bag is disposed in an ink cartridge equipped with an ink storage is disclosed in Japanese Patent Laid-Open No. 2004-148781. Japanese Patent Laid-Open No. 2004-148781 adopts a configuration in which the waste-ink bag has a gas-liquid separating member, so that even if gas, such as air, gets mixed in the course of accommodating waste liquid discharged from the liquid ejection head, the gas is discharged to the outside of the waste-liquid bag by means of the gas-liquid separating member.

However, for the configuration described in US 2007/0040874 to achieve the required high-accuracy positioning, it is important to satisfy the following three requirements: (1) To achieve high-accuracy positional relationship in the X-Y direction of the ink-cartridge positioning fitting potions and the pressure-fluid inlet to the pressure chamber. (2) To achieve high-accuracy positional relationship in the X-Y direction of the ink-jet-printer positioning mechanism and the pressure-applying mechanism. (3) To ensure the reliability of fitting of the ink cartridge with the ink-jet printer. Unless they are satisfied, it is impossible to supply ink by applying desired pressure to the pressure chamber of the ink cartridge. Therefore, it is necessary to arrange the components with high-accuracy positioning relationship. To satisfy the above requirements, the problems of yields and an increase in the costs of the components, a design problem, etc. may arise.

Meanwhile, unless the pressure chamber is separated from the pressure-applying mechanism before the liquid inlet is separated from the ink supply channel, that is, if the liquid inlet is separated first, with the pressure left in the pressure chamber, the ink may leak from the liquid inlet.

Furthermore, with the configuration disclosed in Japanese Patent Laid-Open No. 7-81089, recovered waste ink tends to gather at the connection with the negative-pressure suction pump, which sometimes makes it difficult to use the entire region of the waste ink absorber as a waste-ink recovery region.

Furthermore, with the ink cartridge described in Japanese Patent Laid-Open No. 2004-14878, the waste-ink bag must have the air-liquid separating member, which poses the problem of complicating the configuration of the ink cartridge.

### SUMMARY OF THE INVENTION

The present invention ensures simple, reliable mountability of a liquid container to a liquid ejecting apparatus.

The present invention provides a liquid container capable of stable liquid supply and waste-liquid recovery without taking in air or generating leakage of ink even if the liquid container is dismounted in use.

According to an aspect of the present invention, there is provided a liquid container that can be mounted to and dismounted from a liquid ejecting apparatus. The liquid container includes a housing; a flexible reservoir disposed in the housing and having a joint member joined to a liquid transfer channel provided in the liquid ejecting apparatus; a fitted portion fitted on a positioning mechanism provided on the liquid ejecting apparatus; and an inner-pressure-changing connecting portion connected to an inner-pressure changing mechanism of the liquid ejecting apparatus and changing the pressure in the housing to deform the flexible reservoir, the inner-pressure-changing connecting portion being disposed coaxially with the fitted portion.

### BRIEF DESCRIPTION OF THE DRAWINGS

FIG. 1 is a schematic diagram of a liquid supply system incorporating the present invention.

FIG. 2 is a perspective view of an ink cartridge and a mounting member of an ink-jet printer according to a first embodiment of the present invention.

FIG. 3 is an exploded view of the ink cartridge according to the first embodiment shown in FIG. 2.

FIG. 4 is a plan view of one side of the ink cartridge according to the first embodiment.

FIG. 5 is a cross-sectional view of the ink cartridge according to the first embodiment shown in FIG. 4, taken along line V-V′, showing the structure of connection with the ink-jet printer.

FIG. 6A is a diagram illustrating a state in which the ink cartridge is fitted in the ink-jet printer.

FIG. 6B is a diagram illustrating a state in which the ink cartridge is being dismounted.

FIG. 6C is a diagram illustrating a state in which the ink cartridge has been dismounted.

FIG. 7 is a schematic diagram illustrating a state in which an ink bag is broken.

FIG. 8 is a schematic diagram illustrating an ink cartridge according to a second embodiment of the present invention.

FIG. 9 is a plan view of one side of an ink cartridge according to a third embodiment of the present invention.

### DESCRIPTION OF THE EMBODIMENTS

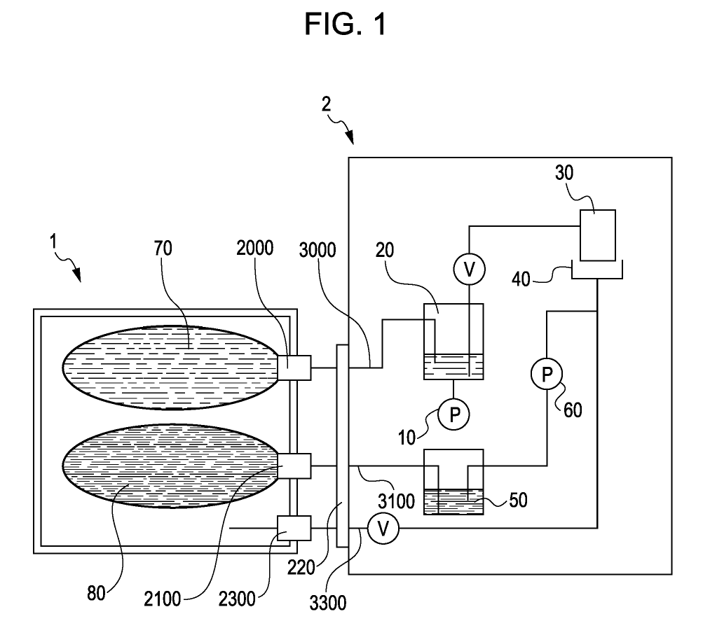

Referring to FIG. 1, a liquid ejection system using a liquid container according to an embodiment of the present invention and liquid transfer channels in a liquid ejecting apparatus will be described. A liquid container (ink cartridge) 1 incorporating the present invention has several connecting structures. These connecting structures can be attached to or detached from connection structures provided at a mounting member 220 of a liquid ejecting apparatus (ink-jet printer) 2 to construct a liquid ejection system equipped with the liquid container 1 and the liquid ejecting apparatus 2. The housing of the liquid container 1 accommodates a liquid reservoir (ink bag) 70 and a waste-liquid reservoir (waste-ink bag) 80 which are flexible reservoirs. The liquid reservoir 70 is for storing liquid to be supplied to the liquid ejecting apparatus 2. The waste-liquid reservoir 80 is for recovering and storing waste liquid discharged from the liquid ejecting apparatus 2. As described above, the liquid container 1 has several connecting structures, for example, a liquid-supply joint member (ink-supply joint member) 2000, a waste-liquid-recovery joint member (waste-ink-recovery joint member) 2100, and an inner-pressure-changing connecting portion 2300. The inner-pressure-changing connecting portion 2300 can be used as a pressure-applying connecting portion or a pressure-reducing connecting portion.

The mounting member 220 of the liquid ejecting apparatus 2 has a leading end 3000 of a liquid supply channel, a leading end 3100 of a waste-liquid recovery channel, and a trailing-end structure 3300 of an inner-pressure changing mechanism, which are connected to corresponding connecting portions and joint members when the liquid container 1 is mounted thereto.

The liquid ejecting apparatus 2 has two liquid transfer channels, one of which is a liquid supply channel through which liquid is supplied from the liquid container 1 through a subtank 20 to a liquid ejection head 30, and the other is a waste-liquid recovery channel through which waste liquid, which was not used for recording generated due to the recovery operation of the liquid ejecting apparatus 2, such as a preejecting operation, is recovered via a relay tank 50.

A method for supplying liquid from the liquid reservoir 70 to the subtank 20 includes a method of reducing the pressure in the subtank 20 by driving a suction pump 10 attached to the subtank 20. Another method for supplying liquid from the liquid reservoir 70 to the subtank 20 is a method of bringing the interior of the liquid container 1 into a compressed state using, for example, a pump 60 that constitutes the inner-pressure changing mechanism (here, the inner-pressure changing mechanism functions as a pressure-applying mechanism), to exert a force to reduce the volume of the liquid reservoir 70.

An example of a method for supplying liquid from the subtank 20 to the liquid ejection head 30 uses a difference in hydraulic head. Another method supplies liquid by applying pressure to the interior of the subtank 20. This supply method using pressure is effective in high-speed recording.

The liquid ejection head 30 is held at a home position or the like, during storage, at which a cap 40 for preventing drying is disposed. The liquid ejection head 30 is held at the position of the cap 40 also when performing recovery operations, such as a preejecting or a liquid sucking operation, for maintaining or recovering the ink ejection state of the liquid ejection head 30. For the liquid sucking operation, the liquid ejection head 30 is covered with the cap 40, and negative pressure is generated using the pump 60 connected to the cap 40 to suck liquid from the liquid ejection head 30. The waste liquid generated due to these operations is temporarily collected in the relay tank 50 that constitutes the waste-liquid recovery channel. Thereafter, the pressure of the interior of the sealed liquid container 1 is reduced (here, the inner-pressure changing mechanism functions as a pressure-reducing mechanism) to exert a force to expand the waste-liquid reservoir 80. Thus, the waste liquid is recovered from the relay tank 50 into the waste-liquid reservoir 80.

In this way, changing the internal pressure of the liquid container 1 allows the volume of the flexible liquid reservoir 70 or 80, allowing supply or recovery of the liquid.

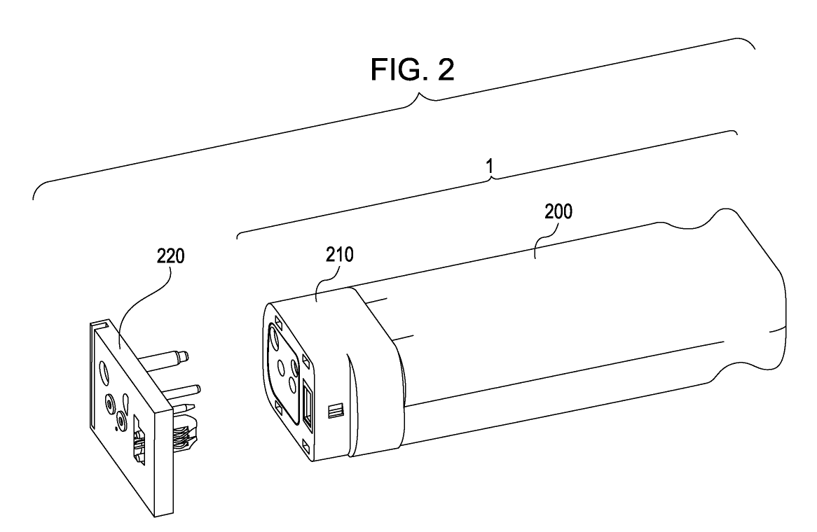

A first embodiment of the liquid container 1 for use in the liquid ejection system described in FIG. 1 will be described. FIG. 2 is a perspective view of the connection of the ink cartridge 1 and the mounting member 220 of the ink-jet printer 2 according to the first embodiment of the present invention. The ink cartridge 1 includes a tank cover 210 for a tank case 200. The tank cover 210 has claws (not shown) at four ends, which fit in depressions (not shown) of the tank case 200. This prevents the ink cartridge 1 from being broken if it is vibrated or dropped during transportation. This is constructed to be easily disassembled by disengaging the claws by inserting a jig between the tank cover 210 and the tank case 200 in consideration of recycling. This ink cartridge 1 is mounted to the ink-jet printer 2 by engagement with one of a plurality of the mounting members 220 of the ink-jet printer 2.

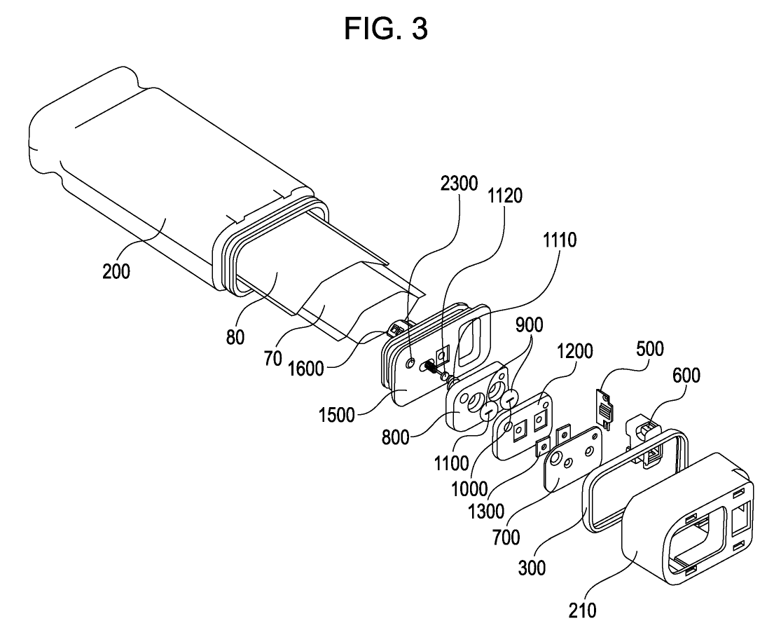

FIG. 3 is an exploded view of the ink cartridge 1 shown in FIG. 2. The tank case 200 accommodates the ink bag 70 and the waste-ink bag 80. The part other than the ink bag 70 and the waste-ink bag 80 in the tank case 200 is the part to be decompressed (decompression chamber). The pressure-reducing connecting portion (pressure-changing connecting portion) 2300 of the ink cartridge 1 is configured as an opening to communicate the interior (serving as the decompression chamber) of the ink cartridge 1 with the air when the ink cartridge 1 is not mounted. When the ink cartridge 1 is mounted to the mounting member 220, as shown in FIG. 1, the pressure-reducing connecting portion 2300 connects to the trailing-end structure 3300 of the pressure-reducing mechanism of the ink-jet printer 2 to seal the opening of the pressure-reducing connecting portion 2300. Thus, the interior of the ink cartridge 1 is sealed, and the pressure-reducing mechanism is operated to bring the decompression chamber of the ink cartridge 1 into a decompressed state.

Examples of the flexible material for the ink bag 70 and the waste-ink bag 80 include polyethylene film, polypropylene film, nylon film, and aluminum foil. The shape of the ink bag 70 can easily be changed through the use of a flexible material, which facilitates ink supply, thus allowing the ink to be used up. This embodiment uses a three-layer structure of polyethylene film, polypropylene film, and nylon film in this order from the inside.

The waste-ink bag 80 is easily deformed due to changes in inner pressure applied by the pressure-reducing mechanism owing to the use of a flexible material, thus allowing waste ink to be easily recovered. This embodiment uses aluminum-laminated film formed of polypropylene film, nylon film, aluminum foil, and nylon film in this order from the inside.

In this embodiment, as shown in FIG. 3, the ink bag 70 adopts a configuration in which it is disposed inside the waste-ink bag 80. With this configuration, only the innermost layer of the ink bag 70 should be made of a material having a good ink-wet performance (having the property that the component of the material is hardly eluted even in contact with ink). In contrast, the outermost layer of the ink bag 70 should not be made of a material having a good ink-wet performance because it is in contact with waste ink. On the other hand, the outside waste-ink bag 80 may be made of any material without particular consideration of the ink-wet performance; however, it may be made of aluminum-laminated film having an ink-volatilization preventing function in view of preventing volatilization of ink from the ink bag 70. Since the ink bag 70 and the waste-ink bag 80 are welded to a joint member 1600 of a joint base member 1500, as will be described later, the material may be selected also in consideration of a welding performance to the joint base member 1500.

The ink bag 70 and the waste-ink bag 80 may be independently disposed in the tank case 200, in which case aluminum-laminated film having an ink-volatilization preventing function may be used. As another alternative, the waste-ink bag 80 may be disposed inside the ink bag 70, and the ink-volatilization preventing function may be given to the ink bag 70. In this case, since the outermost layer of the waste-ink bag 80 is in direct contact with ink, a material having a good ink-wet performance is selected as the material for the outermost layer of the waste-ink bag 80.

The ink bag 70 and the waste-ink bag 80 are formed into the bag shape by cutting a rectangular sheet, folding it into halves, and joining both ends by thermowelding. The ink bag 70 and the waste-ink bag 80 are welded to the joint member 1600 of the joint base member 1500. A valve element 1110 and a compression spring 1120 for pushing the valve element 110 are provided at the waste-ink bag 80 side of a waste-ink side joint rubber 900 and function as a check valve for preventing liquid from transferring from the interior of the waste-ink bag 80 to the outside. This can prevent waste ink from leaking from the waste-ink bag 80 to the outside even if the used ink cartridge 1 which has recovered waste ink is given an impact due to falling, vibration, etc.

To the joint base member 1500, a rubber receiving member 800, a rubber holding member 1200, and an absorber holding member 700 are welded. The joint base member 1500 is fixed to the tank case 200 with a metal fastener 300. An O-ring may be provided between the tank case 200 and the joint base member 1500 with no gap therebetween, thus allowing sealing. The metal fastener 300 is formed so as to be easily detached from the tank case 200 and the joint base member 1500 in consideration of recycling of the ink cartridge 1.

The two joint rubbers 900 are fitted between the rubber receiving member 800 and the rubber holding member 1200. In the centers of the joint rubbers 900, an ink hole 1000 to which the ink supply channel of the ink-jet printer 2 is connected and a waste-ink hole 1100 to which the waste-ink recovery channel is connected are formed, respectively. The joint rubbers 900 are fitted in compression between the rubber receiving member 800 and the rubber holding member 1200. Therefore, when the ink cartridge 1 is not connected to the ink-jet printer 2, the ink hole 1000 and the waste-ink hole 1100 are compressed to prevent ink leakage from the ink cartridge 1. The joint rubbers 900 may not have the ink holes 1000 and 1100.

Two absorbers 1300 are provided between the rubber holding member 1200 and the absorber holding member 700, so that even if a minute amount of ink leaks when the ink cartridge 1 is mounted to or dismounted from the ink-jet printer 2, it can be absorbed. Furthermore, an information-storage-medium holding member 600 having a rewritable information storage medium 500 is disposed on the joint base member 1500, with which data is exchanged between the ink cartridge 1 and the ink-jet printer 2. This information storage medium 500 can store the amount of ink remaining in the ink bag 70 and the amount of waste ink remaining in the waste-ink bag 80. This allows the state of the ink cartridge 1 to be obtained even if the ink cartridge 1 is removed in use, and the use can be continued without ink leakage caused by recovering more than a permissible amount of waste ink into the waste-ink bag 80.

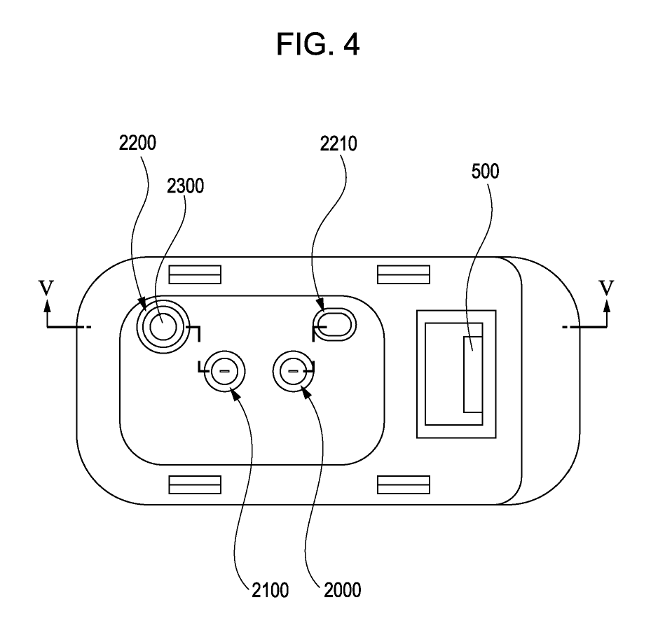

FIG. 4 is a plan view of one side of the ink cartridge 1, which is provided with the ink-supply joint member 2000 having the ink hole 1000 through which ink is supplied from the ink bag 70 and the waste-ink-recovery joint member 2100 having the recover waste-ink hole 1100 through which waste-ink is recovered into the waste-ink bag 80.

Two fitted portions 2200 and 2210 are provided on the same side as the side on which the ink-supply joint member 2000 and the waste-ink-recovery joint member 2100 are provided. The two fitted portions 2200 and 2210 fit on the positioning mechanism of the ink-jet printer 2 to achieve high-accuracy three-dimensional positioning of the ink-jet printer 2 and the ink cartridge 1. The pressure-reducing connecting portion 2300 is provided coaxially with one fitted portion 2200.

This embodiment adopts a configuration in which waste ink is recovered from the relay tank 50, shown in FIG. 1, into the waste-ink bag 80 by exerting a force in the direction in which the waste-ink bag 80 is expanded by reducing the pressure in the ink cartridge 1 through the pressure-reducing connecting portion 2300. This needs a configuration in which the interior of the ink cartridge 1 is sealed when fitted in the ink-jet printer 2, which requires high positioning accuracy for the fitted portions 2200 and 2210 and the pressure-reducing connecting portion 2300 which are to be fitted on the positioning mechanisms of the ink-jet printer 2. To achieve this high positioning accuracy, the following three requirements must be satisfied: (1) Achieving high-accuracy positional relationship in the X- and Y-directions of the fitted portions and the pressure-reducing connecting portion of the ink cartridge 1; (2) Achieving high-accuracy positional relationship in the X- and Y-directions of the positioning mechanism and the pressure-reducing mechanism of the ink-jet printer 2; (3) Ensuring the reliability of fitting of the ink cartridge 1 and the ink-jet printer 2. In particular, the reliability of the connection between the pressure-reducing connecting portion 2300 and the trailing-end structure 3300 of the pressure-reducing mechanism is important because it is responsible for whether waste ink can be recovered. Thus, the use of the configuration in which the fitted portion 2210 and the pressure-reducing connecting portion 2300 are disposed coaxially allows high-accuracy positioning to be achieved at a time. This simplifies the connecting structure of the ink cartridge 1, thereby increasing manufacturing yields, reducing material costs, and facilitating designing. In this embodiment, the fitted portion 2210 and the pressure-reducing connecting portion 2300 disposed coaxially are provided at one corner on one side of the ink cartridge 1, in particular, in the vicinity of two sides of the ink cartridge 1. This coaxial disposition of the fitted portion 2210 and the pressure-reducing connecting portion 2300 at such a location uses the strength of the sides to ensure the strength of the joined portion.

Furthermore, the information storage medium 500 is provided on the same side as the ink-supply joint member 2000 and the waste-ink-recovery joint member 2100. Disposing all the fitted portions on the same side of the ink cartridge 1 in this way can simplify the connecting structure. For the arrangement of the components in the tank case 200, the internal space can be used efficiently.

The pressure-reducing connecting portion 2300 may be disposed higher in the direction of gravity than the ink-supply joint member 2000 and the waste-ink-recovery joint member 2100 when mounted to the ink-jet printer 2. Ink can leak through the ink hole 1000 or the waste-ink hole 1100 when the ink cartridge 1 is dismounted from the ink-jet printer 2. If the pressure-reducing connecting portion 2300 is disposed at a lower part, the ink may enter the ink cartridge 1 or the pump 60 in the ink-jet printer 2 to break the ink-jet printer 2. As shown in even, for example, if the ink bag 70 or the waste-ink bag 80 breaks down in the tank case 200 to cause ink leakage, the ink can be prevented from flowing into the pump 60 by disposing the pressure-reducing connecting portion 2300 higher in the direction of gravity.

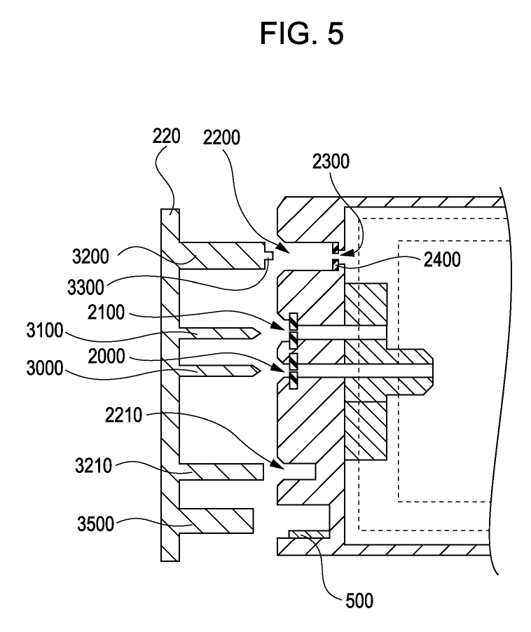

FIG. 5 is a schematic sectional view of V-V′ cross section of FIG. 4 and a cross section of the mounting member 220 of the ink-jet printer 2 in combination. The leading end 3000 of the ink supply channel and the leading end 3100 of the waste-ink recovery channel of the ink-jet printer 2 are joined to the ink-supply joint member 2000 and the waste-ink-recovery joint member 2100 of the ink cartridge 1, respectively, to allow supply of ink and recovery of waste ink. Leading-end structures 3200 and 3210 of the positioning mechanism fit in the fitted portions 2200 and 2210 to allow three-dimensional positioning. The leading-end structure 3200 of the positioning mechanism is provided with a trailing-end structure 3300 of the pressure-reducing mechanism, which connects to the pressure-reducing connecting portion 2300 of the ink cartridge 1. This connecting portion has an elastic sealing member 2400 to allow the sealing of the interior of the ink cartridge 1 to be maintained when the trailing-end structure 3300 of the pressure-reducing mechanism and the pressure-reducing connecting portion 2300 are connected. The elastic sealing member 2400 is provided not at the trailing-end structure 3300 of the pressure-reducing mechanism but at the pressure-reducing connecting portion 2300 of the ink cartridge 1. Therefore, the sealing member 2400 can be replaced with a new elastic sealing member at the same time the ink cartridge 1 is replaced. Since the elastic sealing member 2400 is replaced regularly, the sealing of the interior of the ink cartridge 1 can be ensured with high reliability when the trailing-end structure 3300 of the pressure-reducing mechanism and the pressure-reducing connecting portion 2300 are connected.

Furthermore, an information-storage-medium connection terminal 3500 is connected to the information storage medium 500. Although this embodiment shows an example using the information storage medium 500, such an information storage medium may not necessarily be used.

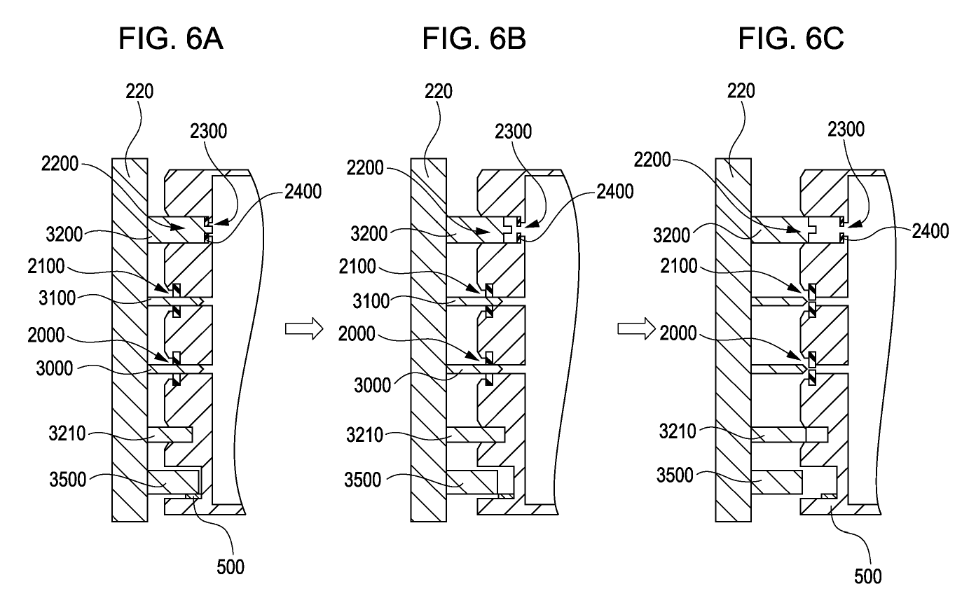

FIGS. 6A to 6C are diagrams illustrating the process of dismounting the ink cartridge 1 of an embodiment of the present invention from the mounting member 220 of the ink-jet printer 2 in sequence. FIG. 6A shows a state in which the ink cartridge 1 is fitted in the ink-jet printer 2; FIG. 6B shows a state in which the ink cartridge is being dismounted; and FIG. 6C shows a state in which the ink cartridge 1 has been dismounted. As shown in FIG. 5 and FIGS. 6A to 6C, the pressure-reducing connecting portion 2300 is disposed closer to the inside of the ink cartridge 1 with respect to the vertical line than the side at which the ink-supply joint member 2000 and the waste-ink-recovery joint member 2100 are disposed. Thus, the trailing-end structure 3300 of the pressure-reducing mechanism is detached from the pressure-reducing connecting portion 2300 before the leading end 3000 of the ink supply channel and the leading end 3100 of the waste-ink recovery channel are detached from the ink-supply joint member 2000 and the waste-ink-recovery joint member 2100, respectively. Since the pressure-reducing connecting portion 2300 is detached first, the interior of the ink cartridge 1 is first communicated with the air to cancel the decompressed state. This eliminates the force to expand the ink bag 70 and the waste-ink bag 80. Thereafter, the leading end 3000 of the ink supply channel and the leading end 3100 of the waste-ink recovery channel are detached from the ink-supply joint member 2000 and the waste-ink-recovery joint member 2100, respectively, to prevent air from entering the ink bag 70 and the waste-ink bag 80.

This solves a problem caused when air enters the ink bag 70, that is, a situation in which air enters the liquid ejection head 30 when the ink cartridge 1 is remounted to the ink-jet printer 1. This eliminates the cause of ejection failure to cause print failure. This also solves another problem caused when air enters the waste-ink bag 80, that is, a situation in which the waste-ink bag 80 expands before waste ink reaches a permissible amount stored in the information storage medium 500. This prevents the recovery from being continued by determining that the waste ink has not reached a predetermined waste-ink amount to damage the waste-ink bag 80, thus preventing ink leakage.

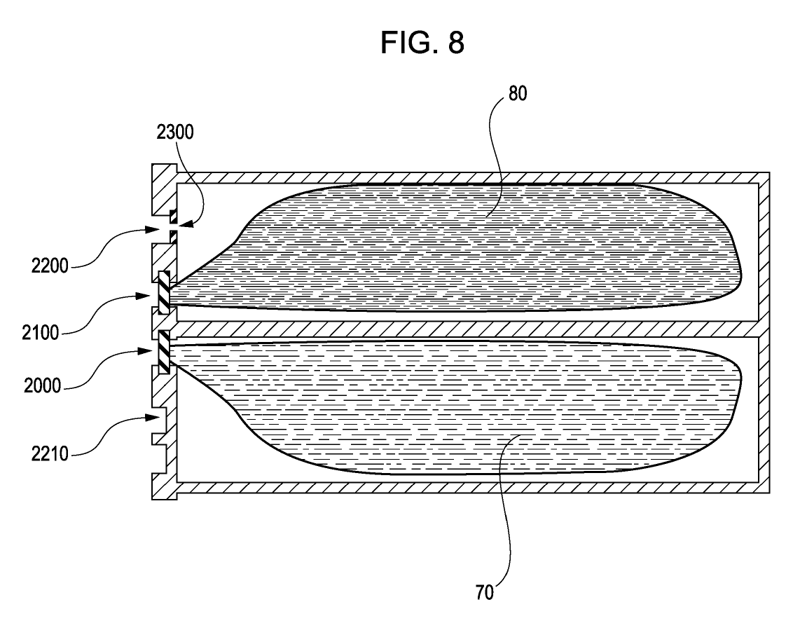

FIG. 8 shows a second embodiment incorporating the present invention. In this embodiment, the interior of the ink cartridge 1 is divided into two chambers. A chamber to which the ink-supply joint member 2000 connects has the ink bag 70, and a chamber to which the waste-ink-recovery joint member 2100 connects has the waste-ink bag 80.

The chamber that accommodates the waste-ink bag 80 is configured to be sealed when the ink cartridge 1 is mounted to the ink-jet printer 2. By reducing the pressure around the waste-ink bag 80, the waste-ink bag 80 can be expanded to recover the waste ink. Since the interior of the ink cartridge 1 is divided into two, the surroundings of the ink bag 70 can be communicated with the air. This allows independent ink supply without reducing the pressure around the ink bag 70. The chamber that accommodates the ink bag 70 can also be configured to be sealed when the ink cartridge 1 is mounted to the ink-jet printer 2. This also allows a liquid supply system to be adopted which supplies ink under pressure by applying pressure to the interior of the chamber using a pressure-applying mechanism (not shown) provided in the ink-jet printer 2 in a sealed state.

Also in this embodiment, the fitted portion 2210 and the pressure-reducing connecting portion 2300 for positioning can be provided coaxially. The order of detachment from the ink-jet printer 2 may be configured such that the pressure-reducing connecting portion 2300 can be first detached from the ink-jet printer 2. This offers the same advantages as the first embodiment.

By coaxially disposing the fitted portion 2210 and the pressure-applying connecting portion (not shown) and by satisfying the detaching sequence, the same advantages as those of the connecting portion of the pressure-reducing mechanism can be provided.

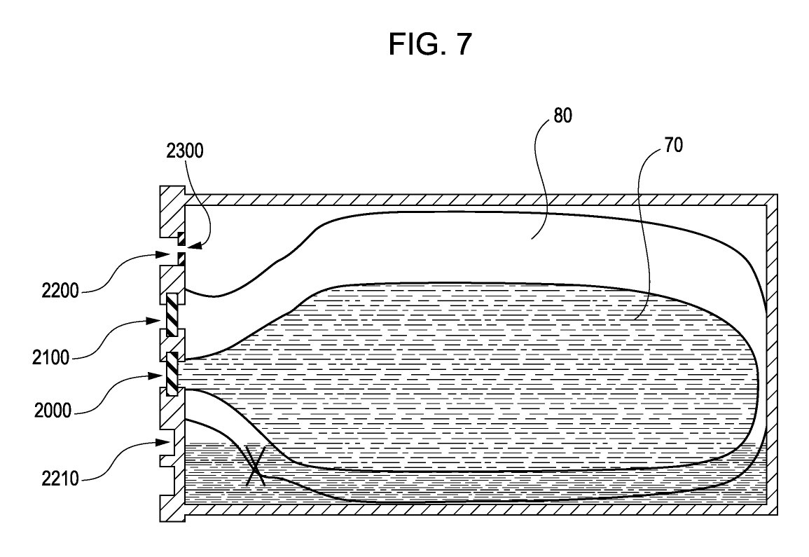

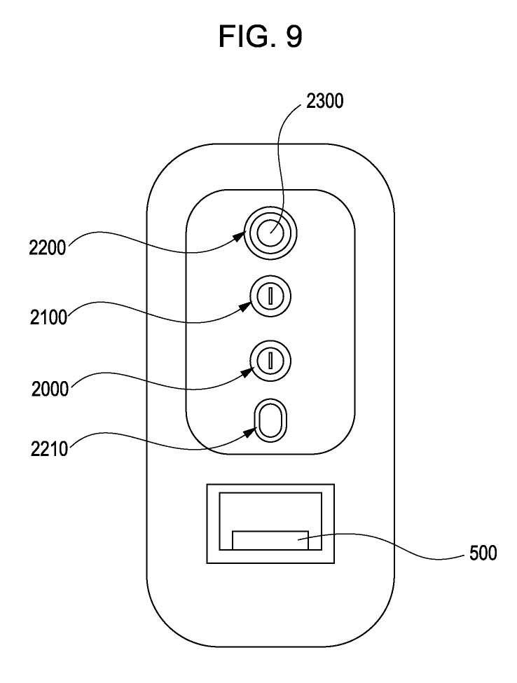

FIG. 9 shows a third embodiment. For the connection structure of the ink cartridge 1, as shown in FIG. 9, the fitted portions 2200 and 2210, the ink-supply joint member 2000, and the waste-ink-recovery joint member 2100 may be arranged on a straight line. In this case, the fitted portion 2200 in which the pressure-reducing connecting portion 2300 is coaxially provided may be disposed higher in the direction of gravity than the ink-supply joint member 2000 and the waste-ink-recovery joint member 2100 when the ink cartridge 1 is mounted to the ink-jet printer 2. This can prevent ink from flowing into the pump 60, as shown in FIG. 7, even if ink leaks from the ink-supply joint member 2000 and the waste-ink-recovery joint member 2100.

The above-described embodiments are described when applied to a liquid container to be used for an ink-jet printer, and the liquid accommodated in the liquid container as ink used in image formation. However, the liquid accommodated in the liquid container is not limited thereto; electrode forming materials for electron emitting displays, light-emitting materials for organic EL displays, gene stocks for DNA chips, etc. may be used.

According to the embodiments of the present invention, the coaxial arrangement of the inner-pressure-changing connecting portion connected to the inner-pressure changing mechanism of the liquid ejecting apparatus to change the inner pressure of the housing of the liquid container and the fitted portions that fit on the positioning mechanism of the liquid ejecting apparatus allows the members that require a high-accuracy fitting performance to be integrated to one. Thus, the fitting-position accuracy of only one member and the liquid ejecting apparatus should be designed with high accuracy, and positioning of the other connecting mechanisms requires not so high accuracy, and therefore, the configuration of the liquid container can be simplified. This improves the connecting reliability of the inner-pressure-changing connecting portion of the liquid container and the inner-pressure changing mechanism, and therefore, a liquid container and a liquid ejection system that can assuredly change the inner pressure to achieve good liquid transfer can be provided. This also contributes to an increase in the yield of the liquid container, cost reduction, and easy designing.

Furthermore, this is configured to disconnect the liquid container from the liquid ejecting apparatus before disconnecting the liquid-supply joint member and the waste-liquid-supply joint member. This allows safe detachment without entering of air into the liquid tank or the waste-liquid tank. This provides a liquid container and a liquid ejection system capable of stable liquid supply and waste-liquid recovery even if the liquid container in use is mounted or dismounted.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-232319 filed on Sep. 10, 2008, which is hereby incorporated by reference herein in its entirety.

What is claimed is:

1. A liquid container that can be mounted to and dismounted from a liquid ejecting apparatus, the liquid container comprising:
a housing;
a flexible reservoir disposed in the housing and having a joint member joined to a liquid transfer channel provided in the liquid ejecting apparatus;
a fitted portion fitted on a positioning mechanism provided on the liquid ejecting apparatus; and
an inner-pressure-changing connecting portion connected to an inner-pressure changing mechanism of the liquid ejecting apparatus and changing the pressure in the housing to deform the flexible reservoir, the inner-pressure-changing connecting portion being disposed coaxially with the fitted portion.

2. The liquid container according to claim 1, wherein
the inner-pressure-changing connecting portion has an elastic sealing member that hermetically seals the interior of the housing by connection with the inner-pressure changing mechanism.

3. The liquid container according to claim 1, wherein
the liquid container has a plurality of the fitted portions, one of the plurality of fitted portions and the inner-pressure-changing connecting portion are coaxially disposed.

4. The liquid container according to claim 1, further comprising:
an information storage medium that connects to an information-storage-medium connection terminal provided at the liquid ejecting apparatus.

5. The liquid container according to claim 4, wherein
the joint member, the fitted portion, the inner-pressure-changing connecting portion, and the information storage medium are disposed on the same side.

6. The liquid container according to claim 1, wherein
the inner-pressure-changing connecting portion is disposed higher in the direction of gravity than the joint member when the liquid container is mounted to the liquid ejecting apparatus.

7. The liquid container according to claim 1, wherein
the joint member, the fitted portion, and the inner-pressure-changing connecting portion are disposed on the same side.

8. The liquid container according to claim 1, wherein
the liquid ejecting apparatus includes a liquid ejection head,
the liquid transfer channel is a channel through which liquid is supplied to the liquid ejection head,
the inner-pressure changing mechanism is a pressure-applying mechanism that deforms the flexible reservoir in the direction of compression, and
the flexible reservoir accommodates the liquid to be supplied to the liquid ejection head.

9. The liquid container according to claim 1, wherein
the liquid transfer channel is a channel through which waste liquid discharged from the liquid ejecting apparatus is recovered,
the inner-pressure changing mechanism is a pressure-reducing mechanism that deforms the flexible reservoir in the direction of expansion, and
the flexible reservoir reserves the waste liquid.

10. The liquid container according to claim 1, wherein
the liquid ejecting apparatus has a liquid ejection head,
the liquid transfer channel includes a first channel through which liquid is supplied to the liquid ejection head and a second channel through which waste liquid discharged from the liquid ejecting apparatus is recovered, and
the flexible reservoir includes a first flexible reservoir that contains the liquid to be supplied to the liquid ejection head and a second flexible reservoir that reserves the waste liquid.

11. The liquid container according to claim 10, wherein
the inner-pressure changing mechanism is a pressure-reducing mechanism and deforms the second flexible reservoir in the direction of expansion.
